(19) United States
(12) Patent Application Publication
(10) Pub. No.: US 2011/0229324 A1
(43) Pub. Date: Sep. 22, 2011

(54) WIND POWER STATION

(76) Inventor: Gerald Hehenberger, Klagenfurt (AT)

(21) Appl. No.: 13/122,015

(22) PCT Filed: Oct. 9, 2009
(86) PCT No.: PCT/AT09/00394

§ 371 Date: Jun. 7, 2011

(30) Foreign Application Priority Data
Oct. 9, 2008 (AT) A 1580/2008

(51) Int. Cl. F03D 11/02

(52) U.S. Cl. 416/170 R

(57) ABSTRACT

An energy production plant, in particular a wind power plant, has a drive shaft, a generator (8), and a differential gear (11 to 13) with three drives and three power take-offs. A first drive is connected to the drive shaft, a power take-off is connected to a generator (8), and a second drive is connected to a differential drive (6). The differential gear (11 to 13) is a planetary gear. The differential drive (6) is connected to the sun wheel (11) of the differential gear (11 to 13), and the differential drive (6) is arranged on the side of the generator (8) that faces away from the differential gear (11 to 13).

The invention relates to an energy production plant, in particular a wind power plant, with a drive shaft, a generator, and with a differential gear with three drives and three power take-offs, whereby a first drive is connected to the drive shaft, a power take-off is connected to a generator, and a second drive is connected to a differential drive, whereby the differential gear is a planetary gear.

Wind power plants are gaining increasing importance as electricity-producing plants. As a result, the proportion, in percent, of power produced by wind is steadily increasing. In turn, this produces, on the one hand, new standards relative to power quality and, on the other hand, a trend toward still larger wind power plants. At the same time, a trend toward off-shore wind power plants is discernible, which requires plant sizes of at least 5 MW of installed output. Here, both the degree of efficiency and also the availability of the plants gain special importance because of the high costs of the infrastructure and maintenance or servicing of the wind power plants in the offshore region.

WO2004/109157 A1 shows a complex, hydrostatic “multipath” concept with several parallel differential stages and several switchable clutches, making it possible to switch among the individual paths. With the indicated technical solution, the output and thus the losses of the hydrostatics can be reduced. A significant drawback, however, is the complicated design of the overall unit. Moreover, the switching between the individual stages represents a problem in the regulation of the wind power plant. In addition, this publication shows a mechanical brake, which acts directly on the generator shaft.

EP 1283359 A1 shows a 1-stage and a multi-stage differential gear with an electric differential drive, whereby the 1-stage version has a special three-phase a.c. machine with high nominal speed that is positioned coaxially around the input shaft and that—as a function of the design—has an extremely high mass moment of inertia relative to the rotor shaft. As an alternative, a multi-stage differential gear with a high-speed standard three-phase a.c. machine is proposed, which is oriented parallel to the input shaft of the differential gear.

The drawbacks of known embodiments are, on the one hand, high losses in the differential drive or, on the other hand, in designs that solve this problem, complex mechanics or special electrical-machine technology, and thus high costs. In general, it can be determined that regulation-relevant criteria, such as, e.g., the mass moment of inertia of the differential drive (J_{red}) relative to the rotor, were not adequately taken into consideration.

The object of the invention is to avoid the above-mentioned drawbacks as much as possible and to make available a differential drive, which, in addition to the lowest possible costs, ensures both maximum energy output and optimum regulation of the wind power plant.

This object according to the invention is achieved in that the differential drive is connected to the sun wheel of the differential gear and in that the differential drive is arranged on the side of the generator that faces away from the differential gear.

As a result, a very compact and efficient design of the plant is possible, with which, moreover, the control-engineering aspects of the energy production plant, in particular the wind power plant, are also optimally achieved.

Preferred embodiments of the invention are the subject of the other subclaims.

Below, preferred embodiments of the invention are described in detail with reference to the attached drawings.

For a 5 MW wind power plant according to the prior art, FIG. 1 shows the output curve, the rotor speed, and the thus resulting characteristic values such as tip speed ratio and output coefficient,

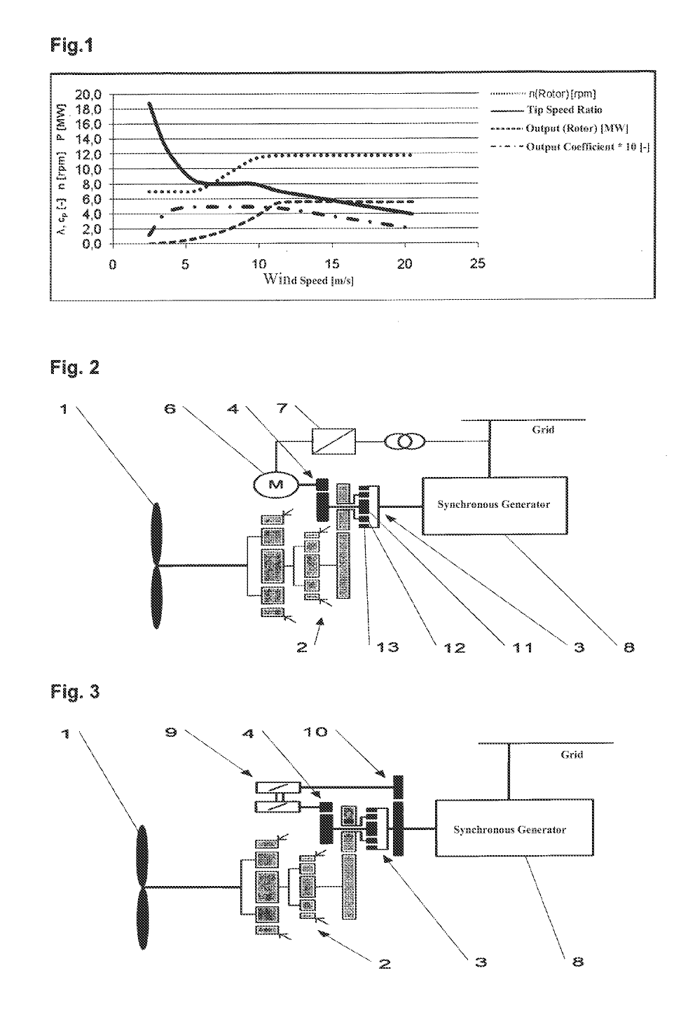

FIG. 2 shows the principle of a differential gear with an electric differential drive according to the prior art,

FIG. 3 shows the principle of a hydrostatic differential drive with a pump/motor combination according to the prior art,

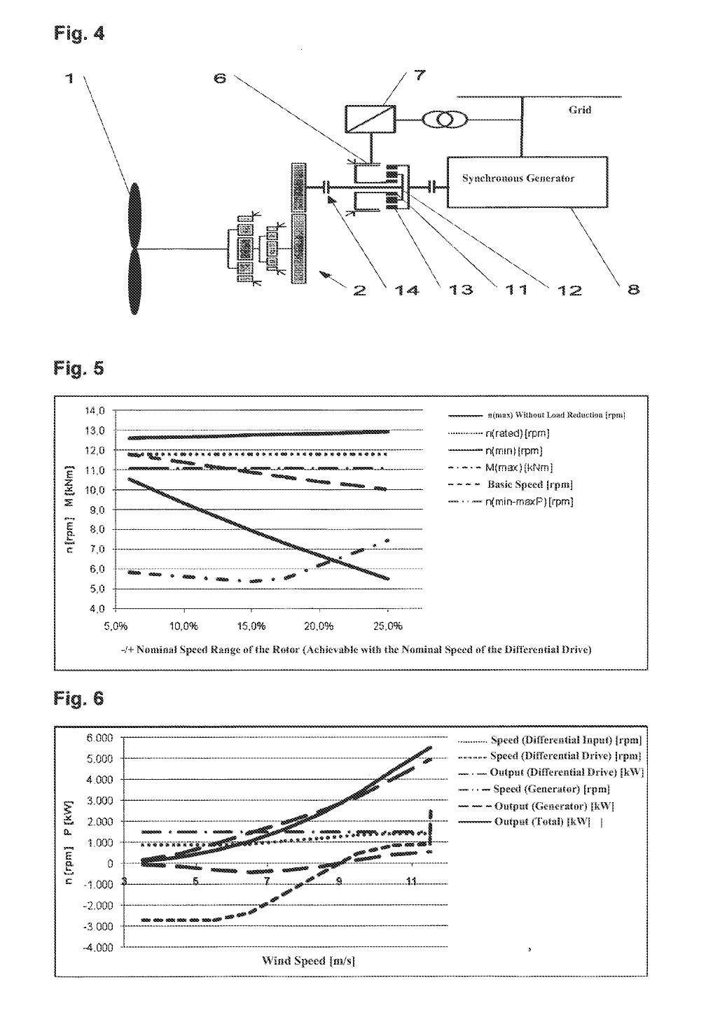

FIG. 4 shows the principle of a special three-phase a.c. machine according to the prior art that is oriented coaxially to the input shaft of the differential stage,

FIG. 5 shows the rotational-speed ratio on the rotor of the wind power plant and the thus resulting maximum input torque Mₘₐₓ for the differential drive,

By way of example, FIG. 6 shows the rotational-speed and output ratios of an electric differential drive over wind speed,

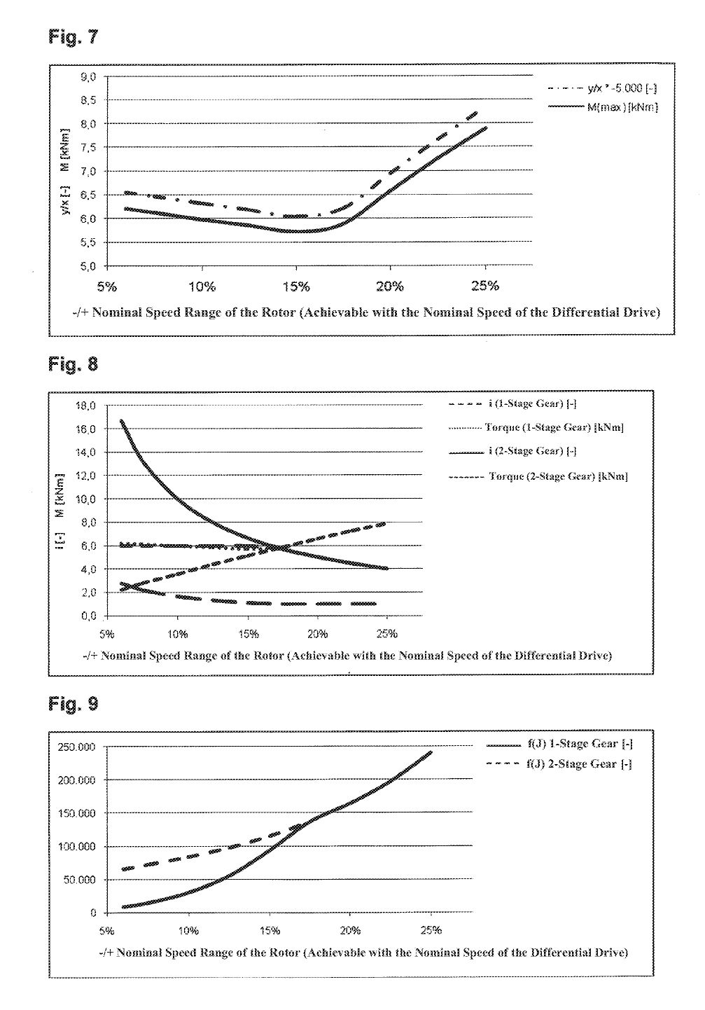

For the 1-stage differential gear, FIG. 7 shows the maximum torque and the size factor y/x as a function of the nominal speed range,

FIG. 8 shows transmission ratios and torques for the differential drive with a 1-stage differential gear and alternatively with a 2-stage differential gear, and the effects on J_{red},

FIG. 9 shows the multiplication factor f(J) for a 1-stage or 2-stage differential gear, with which the value of the mass moment of inertia J of the differential drive can be multiplied to calculate the J_{red} relative to the rotor shaft in the case of the minimum rotor speed (nₘᵢₙ),

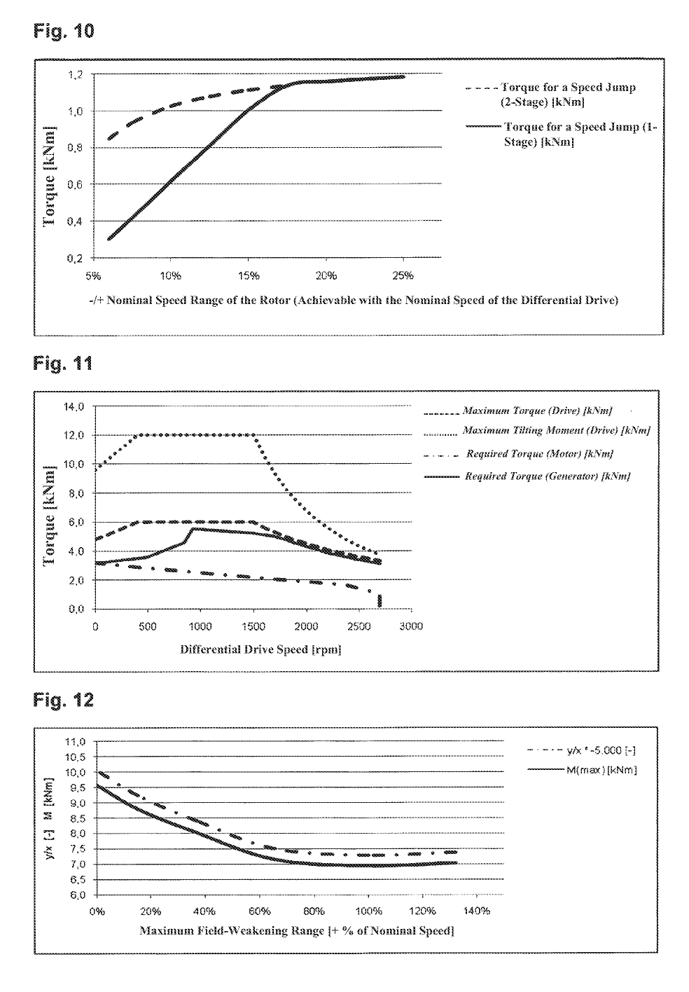

For a 1-stage or 2-stage differential gear, FIG. 10 shows the torque that is necessary to be able to compensate—in terms of speed—for a speed jump at the rotor with an electric differential drive,

FIG. 11 shows the speed/torque characteristic of an electric differential drive (PM synchronous motor) including field-weakening ranges in comparison to the required torque for the differential drive,

FIG. 12 shows the maximum input torque for the differential drive and the size factor y/x as a function of the field-weakening range of the electric differential drive,

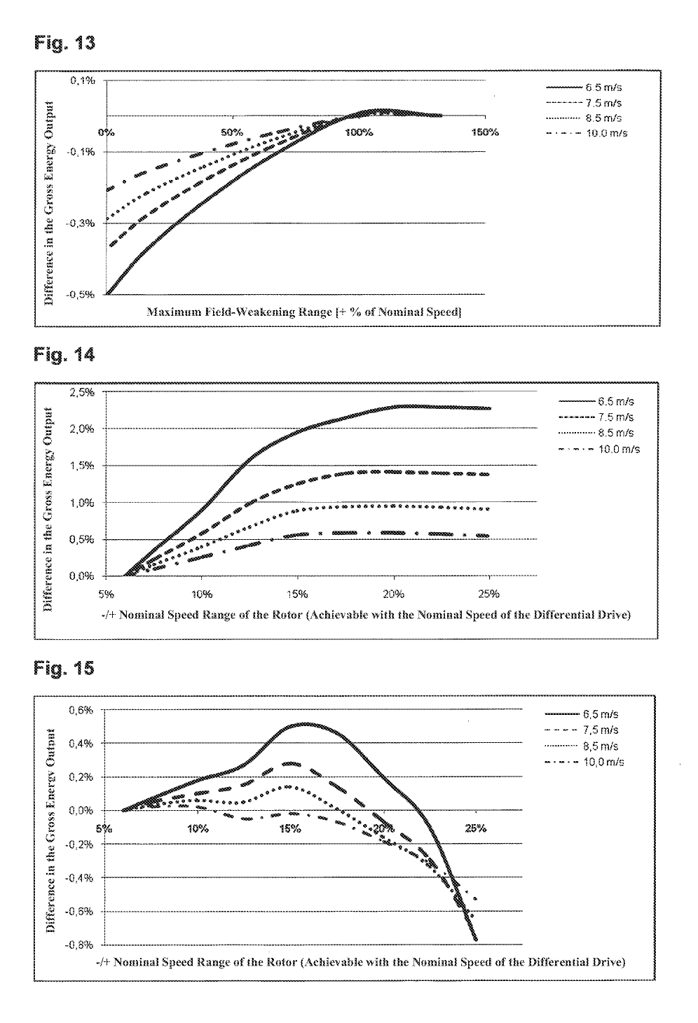

FIG. 13 shows the difference of the gross energy output as a function of the field-weakening range,

FIG. 14 shows the difference of the gross energy output for various nominal speed ranges at different mean annual wind speeds for an electric differential drive with an 80% field-weakening range,

FIG. 15 shows the difference of the gross energy output for various nominal speed ranges at different mean annual wind speeds for a hydraulic differential drive,

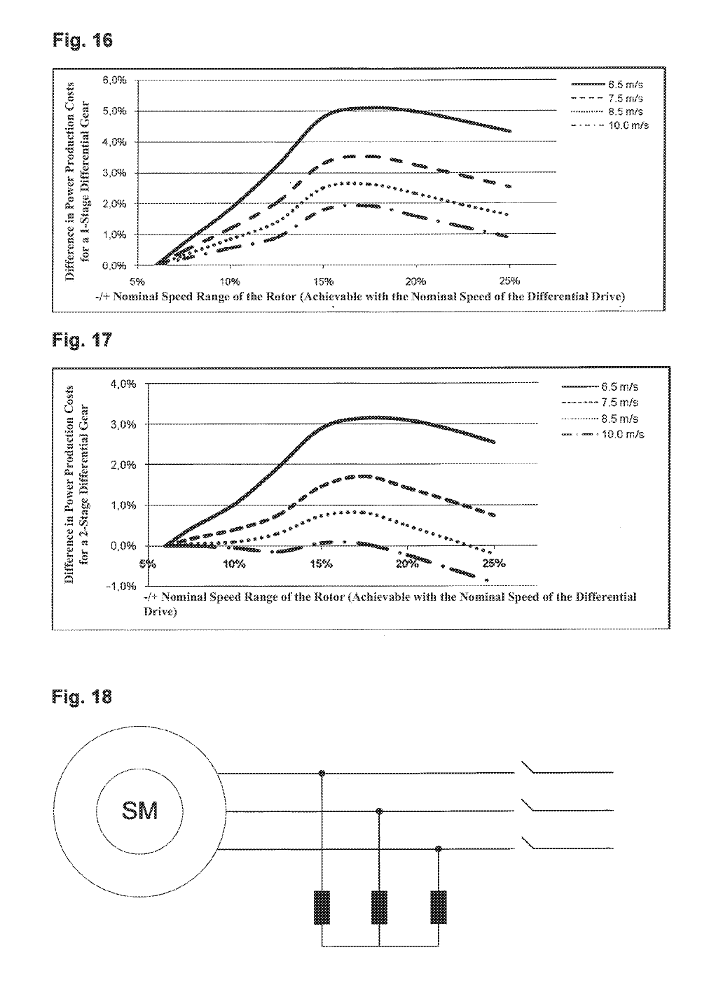

FIG. 16 shows the power production costs for an electric differential drive at various nominal speed ranges for a 1-stage differential gear,

FIG. 17 shows the power production costs for an electric differential drive at various nominal speed ranges for a 2-stage differential gear,

FIG. 18 shows a three-phase a.c. machine that is short-circuited with electric resistors connected in-between,

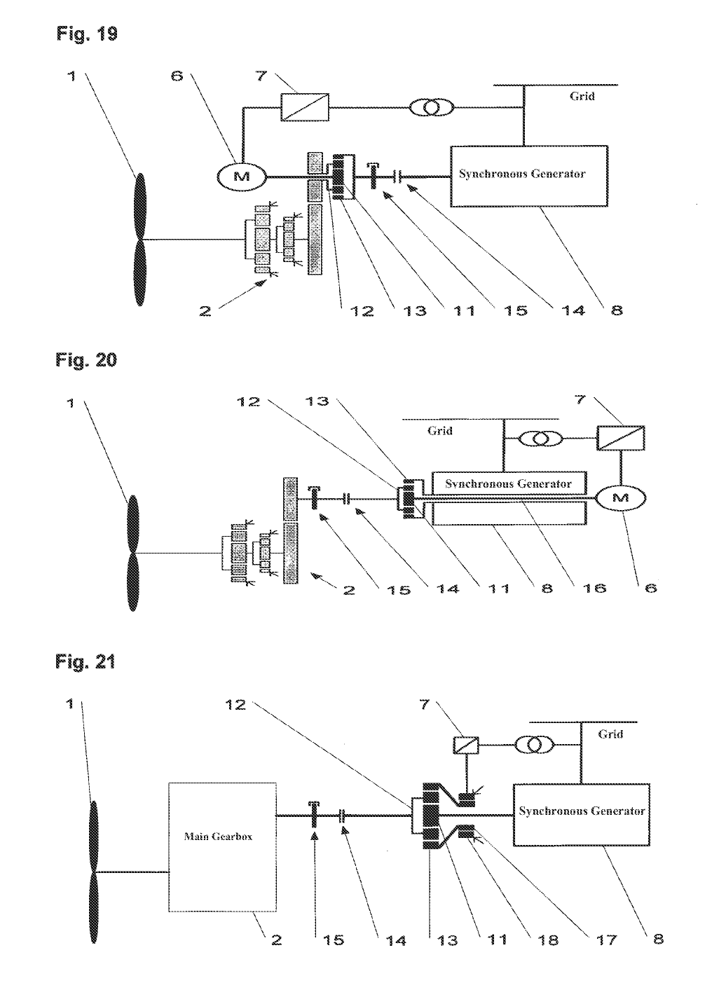

FIG. 19 shows a solution with a 1-stage differential gear that is integrated in the main gearbox,

FIG. 20 shows a solution with a 1-stage differential gear that is integrated in the synchronous generator,

FIG. 21 shows an alternative solution for a 1-stage differential gear with a coaxial connection or a hollow wheel and differential drive.

The output of the rotor of a wind power plant is calculated from the formula

Rotor Output=Rotor Surface Area*Output Coefficient*Air Density/2*Wind Speed³

whereby the output coefficient is based on the tip speed ratio (=ratio of blade tip speed to wind speed) of the rotor of the wind power plant. The rotor of a wind power plant is designed for an optimum output coefficient as a function of a tip speed ratio (in most cases a value of between 7 and 9) that is to be determined during development. For this reason, during operation of the wind power plant in the partial-load range, a correspondingly low speed is to be set to ensure optimum aerodynamic efficiency.

FIG. 1 shows the ratios for rotor output, rotor speed, tip speed ratio and output coefficient for a specified maximum speed range of the rotor or an optimum tip speed ratio of 8.0-8.5. It can be seen from the diagram that as soon as the tip speed ratio deviates from its optimum value of 8.0-8.5, the output coefficient drops, and the rotor output corresponding to the aerodynamic characteristic of the rotor is thus reduced according to the above-mentioned formula.

FIG. 2 shows a possible principle of a differential system for a wind power plant that consists of differential stages 3 or 11 to 13, an adaptive reduction stage 4, and a differential drive 6. The rotor 1 of the wind power plant, which sits on the drive shaft for the main gearbox 2, drives the main gearbox 2. The main gearbox 2 is a 3-stage gearbox with two planetary stages and a spur-wheel stage. Between the main gearbox 2 and the generator 8, there is the differential stage 3, which is driven by the main gearbox 2 via planetary carriers 12 of the differential stage 3. The generator 8—preferably a separately excited synchronous generator, which if necessary can also have a nominal voltage of greater than 20 kV—is connected to the hollow wheel 13 of the differential stage 3 and is driven by the latter. The pinion gear 11 of the differential stage 3 is connected to the differential drive 6. The speed of the differential drive 6 is regulated, on the one hand to ensure, in the case of the variable speed of the rotor 1, a constant speed of the generator 8 and, on the other hand to regulate the torque in the complete drive train of the wind power plant. In the case shown, to increase the input speed for the differential drive 6, a 2-stage differential gear is selected, which provides an adaptive reduction stage 4 in the form of a front-wheel stage between the differential stage 3 and the differential drive 6. The differential stage 3 and the adaptive reduction stage 4 thus form the 2-stage differential gear. The differential drive is a three-phase a.c. machine, which is connected to the grid via a frequency converter 7 and a transformer 5. As an alternative, the differential drive, as shown in FIG. 3, can also be designed as, e.g., a hydrostatic pump/motor combination 9. In this case, the second pump is preferably connected via the adaptive reduction stage 10 to the drive shaft of the generator 8.

FIG. 4 shows another possible embodiment of the differential gear according to the prior art. Here, the planetary carrier 12 is driven from the main gearbox 2 in an already indicated way, and the generator 8 is connected to the hollow wheel 13 or the pinion gear is connected to the electric differential drive 6. This variant embodiment represents a 1-stage solution, whereby here for design reasons, a special three-phase a.c. machine is brought into use, which is significantly more expensive in comparison to the standard three-phase a.c. machines and has, moreover, a very high mass moment of inertia. This has an especially negative effect in terms of control engineering as regards the mass moment of inertia, relative to the rotor 1, of the differential drive 6.

The equation of the speed for the differential gear reads:

Speed_{Generator}=x*Speed_{Rotor}+y*Speed_{Differential Drive},

whereby the generator speed is constant, and the factors x and y can be derived from the selected gear ratios of the main gearbox and the differential gearbox. The torque on the rotor is determined by the available wind supply and the aerodynamic efficiency of the rotor. The ratio between the torque at the rotor shaft and that on the differential drive is constant, by which the torque in the drive train can be regulated by the differential drive. The equation of the torque for the differential drive reads:

Torque_{Differential Drive}=Torque_{Rotor}*y/x,

whereby the size factor y/x is a measurement of the required design torque of the differential drive.

The output of the differential drive is essentially proportional to the product that consists of the percentage deviation of the rotor speed from its basic speed times rotor output. Consequently, a large speed range in principle requires a correspondingly large sizing of the differential drive.

FIG. 5 shows this by way of example for various speed ranges. The −/+ nominal speed range of the rotor defines its percentage speed deviation from the basic speed of the rotor, which can be achieved without field weakening with the nominal speed of the differential drive (− . . . motor and + . . . generator). In the case of an electric three-phase a.c. machine, the nominal speed (n) of the differential drive defines any maximum speed in which the latter can permanently generate the nominal torque (Mₐ) or the nominal output (Pₐ).

In the case of a hydrostatic drive, such as, e.g., a hydraulic reciprocating piston pump, the nominal speed of the differential drive is any speed in which the latter with maximum torque (Tₘₐₓ) can yield maximum continuous output (P_{O max}). In this case, nominal pressure (p_{N}) and nominal size (NG) and displacement volumes of the (V_{g max}) of the pump determine the maximum torque (Tₘₐₓ).

In the nominal output range, the rotor of the wind power plant rotates with the mean speed n_{rated} between the limits nₘₐₓ and n_{min-maxP}, in the partial-load range between n_{rated} and nₘᵢₙ, achievable in this example with a field-weakening range of 80%. The regulating speed range between nₘₐₓ and n_{min-maxP}, which can be achieved without load reduction, is selected to be correspondingly large to be able to compensate for wind gusts. The size of this speed range depends on the gusting of the wind or the inertia of the rotor of the wind power plant and the dynamics of the so-called pitch system (rotor blade adjusting system) and is usually approximately −/+5%. In the example shown, a regulating speed range of −/+6% was selected to have corresponding reserves for the compensation of extreme gusts using differential drives. Wind power plants with very sluggish pitch systems can also be well designed, however, for regulating speed ranges of approximately −/+7% to −/+8%. In this regulating speed range, the wind power plant has to produce nominal output, which means that the differential drive in this case is loaded with maximum torque. This means that the −/+ nominal speed range of the rotor has to be equally large, since only in this range can the differential drive achieve its nominal torque.

In the case of electric and hydrostatic differential drives with a differential stage, the rotor speed, in which the differential drive has the speed that is equal to 0, is named the basic speed. Since now in the case of small rotor speed ranges, the basic speed exceeds n_{min-maxP}, the differential drive has to be able to generate the nominal torque at a speed that is equal to 0. Differential drives, be they electric or else hydraulic, can only produce a torque, however, at a speed that is equal to 0, which is significantly below the nominal torque; but this can be compensated for by corresponding oversizing in the design. Since, however, the maximum design torque is the sizing factor for a differential drive, for this reason a smaller speed range has an only limited positive effect on the size of the differential drive.

In the case of a drive design with more than one differential stage, or with a hydrodynamic differential drive, the −/+ nominal speed range can be calculated in terms of replacement from the formula

−/+ Nominal Speed Range=−/+(nₘₐₓ−nₘᵢₙ)/(nₘₐₓ+nₘᵢₙ)

for a basic speed=(nₘₐₓ+nₘᵢₙ)*0.5

The nominal speed of the differential drive in this case is determined instead in terms of replacement with its speeds at nₘₐₓ and respectively nₘᵢₙ.

In FIG. 6, by way of example, the rotational-speed or output ratios are provided for a differential stage. The speed of the generator, preferably a separately excited mean voltage synchronous generator, is constant through the connection to the constant-frequency power grid. To be able to use the differential drive correspondingly well, this drive is operated in motor mode in the lower range of the basic speed and in generator mode in the higher range of the basic speed. This means that the output in the differential stage is injected in the motor range and output from the differential stage is removed in the generator range. In the case of an electric differential drive, this output is preferably removed in the grid or is fed into the latter. In the case of a hydraulic differential drive, the output is preferably removed in the generator shaft or is fed to the latter. The sum of the generator output and the differential drive output produces the overall output that is released into the grid for an electric differential drive.

In addition to the torque on the differential input, the input torque for the differential drive also essentially depends on the transmission ratio of the differential gear. If the underlying analysis is that the optimum transmission ratio of a planetary stage is in a so-called stationary gear ratio of approximately 6, the torque for the differential drive, with a 1-stage differential gear, is not smaller proportionally to the speed range. Technically, also larger stationary gear ratios can be produced, which at best reduces this problem but does not eliminate it.

For a 1-stage differential gear, FIG. 7 shows the maximum torque and the size factor y/x (multiplied by −5,000 for display reasons) as a function of the nominal speed range of the rotor. In a nominal speed range of approximately −/+14% to −/+17%, the smallest size factor and consequently also the smallest maximum torque (Mₘₐₓ) are produced for the differential drive.

For a 1-stage differential gear, the lay-out shows that in the case of a nominal speed range that becomes smaller, the design torque for the differential drive grows. To solve this problem, e.g., a 2-stage differential gear can be used. This can be achieved, for example, by implementing an adaptive reduction stage 4 between the differential stage 3 and the differential drive 6 or 9. The input torque for the differential stage, which essentially determines the costs thereof, thus cannot be reduced, however.

FIG. 8 shows the juxtaposition of the torques of the differential drive for a 1-stage and a 2-stage differential gear and the factor J(red), which is the ratio of the mass moment of inertia (D_{red}) of both variants relative to the rotor shaft. It can be seen clearly from FIG. 8 that with the free selection of the transmission ratio of the differential gear—in the case shown for a nominal speed of the differential drive of approximately 1,500 rpm—the required torque of the differential drive is correspondingly smaller with a speed range that becomes smaller. Above a nominal speed range of approximately −/+16.5%, the stationary gear ratio of the 1-stage differential gear that is assumed in this embodiment can be achieved by the nominal speed of the differential drive of 1,500 rpm without additional adaptive reduction stages. The drawbacks of a multi-stage differential gear are, however, the somewhat higher gear losses and higher gear costs. Moreover, the higher gear transmission produces a higher mass moment of inertia of the differential drive relative to the rotor shaft of the wind power plant (J_{red}), although the mass moment of inertia of the differential drive is also smaller with nominal torque that becomes smaller. Since the controllability of the wind power plant depends greatly on this J_{red}, however—the lower in comparison to the mass moment of inertia of the rotor of the wind power plant, the better the regulation dynamics of the differential drive—in the case that is shown with a low speed range of the rotor of the wind power plant of approximately 2.6 times, the value of J_{red} for a 2-stage differential gear relative to a 1-stage differential gear is a drawback, which (a) requires a correspondingly larger sizing of the differential drive or (b), if no corresponding compensation measures are taken, because of the poorer regulating properties, it results in higher loads on the wind power plant and poorer power quality. Therefore, and also because of the higher gear costs and losses, a 1-stage differential gear represents a technically possible alternative only conditionally and only with a low nominal speed range relative to multi-stage solutions.

The same argument applies for J_{red} in general also during the selection of the speed range. With a minimum rotor speed, FIG. 9 shows the multiplication factor f(J) with which the value of the mass moment of inertia of the differential drive can be multiplied to calculate the J_{red} of the differential drive, relative to the rotor shaft, at the lowest rotor speed (nₘᵢₙ).

To be able to compensate for speed jumps of the rotor of the wind power plant, the differential drive has to be correspondingly oversized, which represents a significant cost factor with increasing J_{red}, i.e., with an increasing nominal speed range or with a multi-stage differential drive even at lower speed ranges.

FIG. 10 shows the required torque for the differential drive to be able to compensate for a wind gust. If a wind gust that accelerates within 2 seconds from 4.5 m/s to 11.5 m/s is assumed, this will produce—as a function of the nominal speed range of the rotor of the wind power plant—a speed jump of 5.6 to 10.3 rpm to the same speed of 11.7 rpm for all nominal speed ranges. The differential drive has to follow this speed jump, whereby the acceleration torque that is necessary for this purpose drops corresponding to J_{red} and the size of the speed jump. It can be clearly seen that here multi-stage differential gears make higher torque necessary because of the higher gear transmission ratios.

An option with the uniform gear transmission of the differential gear to widen the speed range of the rotor of the wind power plant and thus to increase the energy output is the use of the so-called field-weakening range of electric differential drives such as in the case of an, e.g., permanent magnet-activated synchronous three-phase a.c. machine with a frequency converter.

The field-weakening range is any speed range that lies above the nominal speed of the electric three-phase a.c. machine. For this nominal speed, the nominal torque or the nominal tilting moment is also defined. In the tables and further descriptions, the field-weakening area is defined as a percentage of the speed over the nominal speed—i.e., the, e.g., 1.5-times nominal speed corresponds to a field-weakening range of 50%.

By way of example, FIG. 11 shows the values for the maximum torque or tilting moment of an electric differential drive with a nominal speed of 1,500 rpm. It can be clearly seen that the maximum achievable torques both at a speed that is equal to zero and over the nominal speed are lower. An essential characteristic of the wind power plants is that, however, in the partial-load range, in the example that is shown, this corresponds to, for example, motor operation; the required torques are significantly lower than the maximum allowed. In generator operation, load reduction of the wind power plant is necessary for speeds that are greater than, for example, 1,730 rpm, so that the allowed maximum torques are not exceeded. FIG. 10 shows a field-weakening range of 80%, which reaches up to 1.8 times the nominal speed and which represents a technically reasonable upper limit for the electric drive that is selected for the example.

It is worth mentioning here that, e.g., permanent magnet-activated synchronous three-phase a.c. machines have a very good degree of efficiency in the field-weakening range, which is a significant advantage in connection with the degree of efficiency of the differential drive.

The operation in the field-weakening range is possible for the three-phase a.c. machines as a function of their design up to 50% to 60%, i.e., an approximately 1.5 times to 1.6 times nominal speed without speed feedback; moreover, the use of, e.g., encoders is necessary. Since the use of an encoder represents an additional error source and the so-called encoderless torque or speed regulation is dynamically better, an optimum value can be found between regulation dynamics and optimum annual energy output in the determination of the field-weakening range. This means that with high mean wind speeds and the associated extreme gusts, a field-weakening range can be selected that allows the encoderless regulation to be able to compensate for these gusts accordingly. At low mean wind speeds with somewhat smaller gusts to be compensated for, the optimum annual energy output is taken into account and therefore a largest-possible field-weakening range with speed feedback is selected. This also matches very well the speed characteristic of the differential drive of a wind power plant, which at low wind speeds uses the largest possible speed range in the motor mode.

To verify the effect of the size of the field-weakening range on the size of the differential drive or the energy output of the wind power plant at various average annual wind speeds, the field-weakening range of the differential drive can be varied at a set speed range of the rotor of the wind power plant with simultaneous adaptation of the transmission of the differential gear.

FIG. 12 shows the maximum input torques for the differential drive and the size factor y/x (multiplied by −5,000 for display purposes) as a function of the field-weakening range. Starting from a field-weakening range of approximately 70%, optimal size factors for the differential drive and consequently also the smallest maximum torque (M.) are produced for the differential drive, whereby the absolute minimum is in a field-weakening range of 100%.

FIG. 13 shows the difference of the gross energy output as a function of the field-weakening range for various mean annual wind speeds. The optimum is reached in a field-weakening range of between 100% to 120%. Based on these boundary conditions, a field-weakening range is selected as a function of the conditions of use, but in each case 50%.

The mean annual wind speed is the yearly mean of the wind speed measured at the height of the hub (corresponds to the center of the rotor). The maximum mean annual wind speeds of 10.0 m/s, 8.5 m/s, 7.5 m/s and 6.0 m/s correspond to the so-called IEC type classes 1, 2, 3 and 4. A Rayleigh distribution is adopted as a standard statistical frequency distribution.

Moreover, it is worth mentioning that permanent magnet-activated synchronous three-phase a.c. machines as a differential drive still have the advantage—in comparison to three-phase a.c. machines of a different design—of having a small mass moment of inertia in comparison to the nominal torque, which, as already described, proves advantageous relative to the regulation of the wind power plant, with which the expense of a special design of the differential drive without a mass moment of inertia is always worthwhile.

As an alternative, so-called reluctance machines also have a very small mass moment of inertia at, however, typically higher nominal speeds. It is known that reluctance machines are extremely sturdy, which is especially positive for use in the offshore area.

The size of the differential drive also has, of course, a significant effect on the overall efficiency of the wind power plant. If the above-described embodiments are taken into consideration, the basic finding indicates that a larger speed range of the rotor of the wind power plant produces a better aerodynamic degree of efficiency, but, on the other hand, it also requires a larger sizing of the differential drive. This in turn results in higher losses, which counteracts a better degree of system efficiency (determined by the aerodynamics of the rotor and the loss of the differential drive).

FIG. 14 shows the difference of the gross energy output of the wind power plant with an electric differential drive in various mean annual wind speeds as a function of the nominal speed range of the rotor of the wind power plant. In this case, the gross energy output is based on the exhaust gas supply of the rotor of the wind power plant minus the losses of the differential drive (incl. the frequency converter) and the differential gear. A nominal speed range of −/+6% is the basis, according to the invention, which is necessary by the minimum required regulation speed range in the nominal output range of wind power plants with differential drives, whereby the nominal speed range means any rotor-speed range that can be produced with nominal speed of the differential drive. Moreover, a field-weakening range of up to 80% above the nominal speed of the differential drive is adopted. From the layout, it is easy to detect that the optimum is achieved in a nominal speed range of approximately −/+20%, and a widening of the nominal speed range, moreover, is no longer advantageous.

FIG. 15 shows the difference of the gross energy output of the wind power plant with a hydraulic differential drive at various mean annual wind speeds. Here, the significantly higher losses in the case of hydraulic differential drives have a negative effect on the energy output, by which a nominal speed range between the minimum required −/+6% and the energy output optimum of −/+10% for regulation purposes at high mean annual wind speeds (greater than 8.5 m/s) and −/+15% at lower mean annual wind speeds seems reasonable. The kink in the curve at approximately −/+12% of the nominal speed range results from the high nominal torque of the differential drive at a speed that is equal to 0 in the nominal operating range of the wind power plant and the low transmission in the adaptive reduction stage 4.

Ultimately, it is the purpose to develop a drive train that allows the lowest power production costs. The points relevant to this in the optimization of differential drives are (a) the gross energy output, (b) the production costs of the differential drive, and (c) the quality of the torque or speed regulation of the wind power plant that influences the overall production costs. The gross energy output forms proportionally in the power production costs and thus in the economic efficiency of a wind park. The production costs are in relation to the overall production costs of a so-called wind park, but only with a percentage of the proportional capital costs of the wind power plant to the total costs of the wind park including maintenance and operating costs. On average, this wind power plant-specific proportion of the power production costs is approximately ⅔ in the so-called onshore projects and is approximately ⅓ in offshore projects. On average, therefore, a percentage of approximately 50% can be defined. This means that a difference in the annual energy output can be regarded as twice as high, on average, as the difference in the production costs of the wind power plant. This means that when—in the example that is shown of an electric differential drive—an optimum size factor is already set in a nominal speed range of approximately −/+14% to −/+17%, this cost-determining factor has less effect in percentage on the power production costs than the optimum energy output starting from a nominal speed range of approximately −/+20%.

FIG. 16 shows the effects of different speed ranges on the power production costs of the wind park with a 1-stage differential gear and electric differential drive. Here, for all wind speed conditions, a very good value can be found in a nominal number range of between −/+15.0% and −/+20.0% and an optimum of approximately −/+17.5%.

FIG. 17 shows the effects of different speed ranges on the power production costs of the wind park with a 2-stage differential gear (below a nominal speed range of approximately −/+16.5%) with an electric differential drive. Primarily at lower mean annual wind speeds, the optimum here can also be found in a speed range of between 15.0% and 20.0%. In the case of mean annual wind speeds of greater than 8.5 m/s, however, a smaller speed range of at least +/−6% to approximately −/+10% also represents an attractive variant for regulation reasons. This means that multi-stage differential gears at very high mean annual wind speeds are on a competitive basis with 1-stage solutions.

In the design of differential drives, however, still other important special cases can be considered. Thus, for example, because of the constant ratio of rotor speed to the speed on the differential drive, a failure of the differential drive can lead to serious damage. One example is the failure of the differential drive at nominal operation of the wind power plant. As a result, the transferable torque on the drive train simultaneously moves toward zero. The speed of the rotor of the wind power plant in this case is preferably suddenly reduced by a quick readjusting of the rotor blade adjustment, and the generator is separated from the grid. Based on the relatively high mass inertia of the generator, the latter changes its speed only slowly. As a result, if the differential drive cannot maintain its torque at least partially without delay, an excess rotation speed of the differential drive is unavoidable.

For this reason, e.g., when using hydrostatic differential drives, a mechanical brake is provided, which in the case of the differential drive failing, prevents excess rotation speeds that are damaging to the drive train. For this purpose, WO2004/109157 A1 shows a mechanical brake that acts directly on the generator shaft and thus can accordingly brake the generator.

The permanent magnet-activated synchronous three-phase a.c. machines that were already mentioned above in several places and that can be used in combination with a frequency converter as a differential drive have the advantage that they are very fail-safe, and a torque up to approximately the level of the nominal moment can be maintained simply by short-circuiting the primary coil with or without electric resistors that are connected in-between. This means that—e.g., in the case of a converter failure—the synchronous three-phase a.c. machine can be automatically short-circuited by a simple electrical switch (fail-safe) and thus a torque is maintained, which at nominal speed can have up to, for example, nominal value and correspondingly decreases with decreasing speed, dropping toward 0 at very slow speeds. As a result, an excess rotation speed of the differential drive is prevented in a simple way.

FIG. 18 shows a possibility of short-circuiting a three-phase a.c. machine with electric resistors that are connected in-between.

In the case of failure of the permanent magnet-activated synchronous three-phase a.c. machine, the speed of the rotor is to be regulated in such a way that the speed of the differential drive does not exceed a critical speed that damages the drive. Based on the measured speeds of generators and rotors of the wind power plant, the speed of the rotor is regulated corresponding to the equation of speed for the differential gear

Speed_{Generator}=x*Speed_{Rotor}+y*Speed_{Differential Drive}

by means of rotor blade adjustment in such a way that the speed of the differential drive does not exceed a specified critical boundary value.

If the regulation of the wind power plant fails, which under certain circumstances can also have the result of a simultaneous failure of the rotor blade regulation and regulation of the differential drive, the short-circuiting of the primary coil of the permanent magnet-activated synchronous three-phase a.c. machine ensures that torque is maintained, which prevents its excess rotation speed. A simultaneous failure of the regulation of the wind power plant and the permanent magnet-activated synchronous three-phase a.c. machine is not to be assumed.

When the wind power plant is, e.g., out of service, an undesirable acceleration of the differential drive can be prevented by short-circuiting the permanent magnet-activated synchronous three-phase a.c. machine.

For the above-described reasons of the optimal wind power plant regulation—the overall degree of efficiency and the simple mechanical design of the differential gear that is at optimum cost—the 1-stage differential gear represents the ideal technical solution. In this connection, there are various approaches for the design integration of the differential drive.

FIG. 19 shows a possible variant embodiment according to this invention. The rotor 1 drives the main gearbox 2, and the latter via the planetary carrier 12 drives the differential stages 11 to 13. The generator 8 is connected to the hollow wheel 13, and the pinion gear 11 is connected to the differential drive 6. The differential gear is 1-stage, and the differential drive 6 is in a coaxial arrangement both on the drive shaft of the main gearbox 2 and on the drive shaft of the generator 8. Since the connection between the pinion gear 11 and the differential drive 6 goes through the spur-wheel stage and the drive shaft of the main gearbox 2, the differential stage is preferably an integral part of the main gearbox 2 and the latter is then preferably connected via a brake 15, which acts on the rotor 1, and a coupling 14 is connected to the generator 8.

FIG. 20 shows another possible variant embodiment according to this invention. The rotor 1 also drives the main gearbox 2 here, and the latter via the planetary carrier 12 drives the differential stages 11 to 13. The generator 8 is connected to the hollow wheel 13, and the pinion gear 11 is connected to the differential drive 6. The differential gear is 1-stage, and the differential drive 6 is in a coaxial arrangement both on the drive shaft of the main gearbox 2 and on the drive shaft of the generator 8. Here, however, a hollow shaft is provided with the generator 8, which makes it possible that the differential drive is positioned on the side of the generator 8 that faces away from the differential gear. As a result, the differential stage is preferably a separate assembly, connected to the generator 8, which then is preferably connected to the main gearbox 2 via a coupling 14 and a brake 15. The connecting shaft 16 between the pinion gear 11 and the differential drive 6 can preferably be designed in a special variant with a low mass moment of inertia as, e.g., a fiber-composite shaft with glass fibers or carbon fibers.

Significant advantages of the coaxial, 1-stage embodiment of both variants shown are (a) the simplicity of the design of the differential gear, (b) the thus high degree of efficiency of the differential gear, and (c) the comparatively low mass moment of inertia of the differential drive 6 relative to the rotor 1. Moreover, in the variant embodiment according to FIG. 19, the differential gear can be fabricated as a separate assembly and implemented and maintained independently from the main gearbox. Of course, the differential drive 6 can also be replaced by a hydrostatic drive, but to do this, a second pump element interacting with the hydrostatic differential drive has to be driven preferably by the generator 8.

For high mean annual wind speeds, an adaptive reduction stage 4 (as shown in principle in FIG. 2 or 3) between differential stages 11 to 13 and the differential drive 6 can be implemented for the embodiments according to FIGS. 19 and 20.

The variant embodiments according to FIG. 19 and FIG. 20 are distinguished relative to the prior art according to FIG. 4 essentially by the applicability of a standard three-phase a.c. machine and the simple and economical design of the differential stage that does not make any hollow-shaft solution for three-phase a.c. machines and pinion gears necessary and have decisive advantages in relation to the rotor shaft (D_{red}) relative to the mass moment of inertia with reference to the regulation of the wind power plant.

The variant embodiments according to FIG. 19 and FIG. 20 are essentially distinguished, however, relative to the effects of a so-called emergency braking of the wind power plant by means of the brake 15. If it is assumed that in the activation of the brake 15, usually a brake torque of up to 2.5 times the nominal moment acts, then the latter will act divided into rotor, generator and differential drive corresponding to their reduced mass moments of inertia. The latter are naturally a function of the mass ratios of the designed wind power plants. As a realistic example, in the nominal operation of a 5 MW wind power plant relative to the brake 15, approximately 1,900 kgm2 for the rotor 1, approximately 200 kgm2 for the synchronous generator 8, and approximately 10 kgm2 for the differential drive 6 can be assumed. This means that a majority (approximately 90% or 2.2 times the rotor nominal moment) of the brake moment acts on the rotor shaft of the wind power plant. Since in the variant embodiment according to FIG. 19, the differential drive now lies in the torque flux between the brake 15 and the rotor 1, it also has to hold the approximately 2.2 times nominal moment corresponding to the constant torque ratios between the rotor and differential drive.

An essential advantage of the variant embodiment according to FIG. 20 is that if the brake 15 fails, its brake moment will not act via the differential gear on the rotor that determines the mass moment of inertia. In this case, only about 9.5% of the brake moment acts on the generator 8 and approximately 0.5% on the differential drive 6. By the arrangement of the brake 15 and the differential gears 11 to 13 shown according to FIG. 19, the short-circuiting of the permanently activated synchronous three-phase a.c. machine makes sense for maintaining the torque in the differential drive, since otherwise, in case of emergency, a torque significantly exceeding its nominal torque would be present.

FIG. 21 shows another possible embodiment of the differential gear. Here, in a way that has already been shown, the planetary carrier 12 is driven by the main gearbox 2, but the generator 8 is connected to the pinion gear 11 and the hollow wheel is connected to the electric differential drive that consists of the rotor 17 and the stator 18. This variant embodiment also represents a coaxial, 1-stage solution, whereby gear-engineering boundary conditions result in a relatively low speed of the rotor 15. In terms of control engineering, this has an especially positive effect with reference to the mass moment of inertia of the differential drive 17 to 18 relative to the rotor 1.

The above-described embodiments can also be implemented in technically similar applications. This primarily relates to hydro-electric power plants for exploiting river and ocean currents. For this application, the same basic requirements apply as for wind power plants, namely variable flow speed. The drive shaft in these cases is driven directly or indirectly by the devices that are driven by the flow medium, for example water. Subsequently, the drive shaft drives the differential gear directly or indirectly.

1. Energy production plant, in particular a wind power plant, with a drive shaft, a generator (8), and with a differential gear (11 to 13) with three drives and three power take-offs, whereby a first drive is connected to the drive shaft, a power take-off is connected to a generator (8), and a second drive is connected to a differential drive (6), whereby the differential gear (11 to 13) is a planetary gear, characterized in that the differential drive (6) is connected to the sun wheel (11) of the differential gear (11 to 13) and in that the differential drive (6) is arranged on the side of the generator (8) that faces away from the differential gear (11 to 13).

2. Energy production plant according to claim 1, wherein the differential drive (6) is arranged coaxially to the shaft of the generator (8).

3. Energy production plant according to claim 1, wherein it has only one differential stage (11 to 13).

4. Energy production plant according to claim 1, wherein it has a one-stage differential gear (3).

5. Energy production plant according to claim 1, wherein it has a multi-stage differential gear (3, 4).

6. Energy production plant according to claim 1, wherein the drive shaft is the rotor shaft of a wind power plant.

7. Energy production plant according to claim 1, wherein a connecting shaft (16) is constructed between the pinion gear (11) and the differential drive (6) as a fiber-composite shaft.

8. Differential gear according to claim 1, wherein the differential drive (6) is an electric machine.

9. Differential gear according to claim 8, wherein the electric machine (6) is a three-phase a.c. machine.

10. Differential gear according to claim 8, wherein the electric machine (6) is a permanent magnet-activated synchronous three-phase a.c. machine.

11. Differential gear according to claim 8, wherein the electric machine (6) can be short-circuited.

12. Energy production plant according to claim 8, wherein the electric machine (6) can be operated in the field-weakening range, and wherein the electric machine (6) is operated at least at times in a field-weakening range of at least 50%.

13. Energy production plant according to claim 8, in which the first drive
